(19) United States
(12) Patent Application Publication
(10) Pub. No.: US 2001/0035858 A1
(43) Pub. Date: Nov. 1, 2001

(54) Keyboard input device

(76) Inventor: J. Seth Blumberg, Los Angeles, CA (US)

Correspondence Address: OPPENHEIMER WOLFF & DONNELLY LLP, 38TH FLOOR, 2029 CENTURY PARK EAST, LOS ANGELES, CA, 90067-3024, US

(21) Appl. No.: 09/834,561

(22) Filed: Apr. 13, 2001

Related U.S. Application Data
(60) Provisional application No. 60/197,624, filed on Apr. 13, 2000.

(51) Int. Cl. G09G 5/00

(52) U.S. Cl. 345/168

(57) ABSTRACT

A keyboard system permits inputting of data where an input source is responsive to the non-physical touch of fingers. A software program coordinates and interpreting the output signal into discrete letters and other symbols commonly found on a keyboard. A wireless connection can be used, and trigonometrical measurements facilitate location in relation to fingers of a typist. A triangulation device senses finger movement displayed on a monitor, which selectively represents the keyboard. The keyboard allows a typist to be mobile while inputting data into a computer processor.

### RELATED APPLICATIONS

The present invention relates to Provisional Application Ser. No. 60/197,624, filed Apr. 13, 2000, and entitled “Keyboard Input Device”, the contents of which are incorporated by reference herein.

### BACKGROUND OF THE INVENTION

This invention relates to keyboards for computers of all sizes, and particularly the of the smaller size, palm top personal assist devices, and keyboards for phones such as cell phones.

Another problem is that the prior art does not allow for a keyboard that easily facilitates a portable, wearable computer with possibly wireless connections. This invention additionally enables a user to be more mobile while using a keyboard input to facilitate a computer or a computer program.

This invention is directed to minimizing these problems.

### SUMMARY OF THE INVENTION

The invention relates to a device, machine, system or method for a keyboard. system. The keyboard system permits the task of typing or inputting words and other information with a combination of devices connected with a software program that coordinates and interprets the persons input into discrete letters and other symbols commonly found on a typewriter or computer keyboard.

In one form of the invention there is a keyboard system that takes much less space than a conventional keyboard, chording device, or other input device in the prior art.

The invention is a for a keyboard system, and method of keyboarding to permit typing or inputting of data to a receiving device. There is an input source responsive to the non-physical touch of fingers of an operator to generate an output signal. A receiving device receives the output signal. A software program is connected between the input source and receiving device for coordinating and interpreting the output signal into discrete letters and other symbols commonly found on a typewriter or computer keyboard.

In one form the keyboard system is wirelessly connected to a computer processor. There are means for using trigonometrical measurements of location in relation to fingers of a typist. Movements of the fingers can be transmitted remotely to a computer processor, optionally via the Internet.

Further there is a monitor feedback device for a typist, the monitor being for showing the layout of the keyboard and the outline of the fingers hovering over the keyboard. The triangulation device determines the relative points in mid air where fingers are located as related to and compared to the outline of the fingers as represented on the monitor. The triangulation device senses finger movement displayed on the monitor, which selectively represents the keyboard.

The keyboard allows a typist to be mobile while inputting data into a computer processor yet still have access to all the keys and symbols of a full keyboard normally associated with a desktop computer. Additional keys, symbols and computer inputs can be added to the keyboard as represented through the invention.

The invented keyboard input device uses trigonometrical measurements of location in relation to the typist's fingers or other sensing of the input of a typist.

The area or machine that senses an input from the typist causes or enables a response on the computer monitor or screen representing the keyboard with letters, numbers and symbols or other inputs is called the “sensory input sensing area” (SISA).

With this invention, the movements of the typist's fingers are remotely sent to the computer processor, optionally via the Internet, and the typist can functionally type by moving her or his fingers in mid air. The typist can functionally type in mid air while the typist looks at a monitor that may also be located farther away from the typist's body than is reachable by the typist.

The monitor serves as a feedback device for the typist in that the monitor shows the layout of the keyboard and also shows the outline of the typist's fingers hovering over the letters of the keyboard. The triangulation device determines the relative points in mid air where the typist fingers are located as related to and compared to the outline of the typist's fingers as represented on the monitor.

This invention includes the appurtenant software program that in conjunction with the physical machinery of the triangulation devices and enables the computer processor to correlate and calculate the position of the typist's fingers.

Alternately the typist can set the program to only sense the locations of a limited number of fingers. The triangulation devices can sense when the typist moves a finger thus indicating that the typist intends to press a letter or key on the keyboard that is represented on the monitor. When the triangulation device senses finger movement which his displayed on the monitor, which selectively also represents the typewriting keyboard.

The computer sends a message to the monitor to show a respective movement in the drawing of the outline representing that individual finger of the typist. When the finger has moved far enough downwards, the appurtenant software program indicates that the specific key and letter has been typed.

This invention creates a more mobile computer and in one embodiment uses wireless connections to a processor.

The software necessary to effectuate the typing system can be accessed through the Internet. A typist could log onto the internet with a wireless, small portable computer and hand attachments which allow sufficient triangulation between them and may look like wrist bracelets and finger rings for the typing fingers that the typist uses to type.

The typist could have memorized the typing keyboard and therefore may not need any physical representation of the keyboard. Another alternative is that the typist can choose to direct the software program either through the internet or directly through the computer hardware to transmit a representation of the computer screen which can have a representation of the keyboard for feedback as to the location of each letter, number or symbol that is typed. The representation could be transmitted back to the typist's portable wireless computer and the typist could then choose to send this image to any nearby television or computer screen or other monitor of any type through a wired or wireless connection.

The typist could direct the input or representation of the typed material to be sent directly from the machine of the Internet and specifically to a host to an address where there is a television, computer screen, or other monitor.

The triangulation devices that are used to determine the position of the typist's fingers could be placed on the shoulders of the typist, for example. The typist could additionally have sensors on his fingers so that the devices on the typist's shoulders could sense the changes in position of the typist's fingers. The typist could be watching the computer monitor which shows the representation of his fingers hovering over the typewriter keys also represented on the monitor. The typist easily sees the representation of the finger moving downwards towards the representation of the key under that drawing or representation of the finger. Then when the typist moves her or his finger downward enough for the setting of sensitivity, the key on the keyboard represented on the monitor appears to be “touched” by the representation of the “finger” and the computer inputs the information of that key having been typed.

In a broad sense of the invention there is provided a system for effecting keying input to a responsive device without necessarily physically engaging that device. The sensing of the typist's input can be done with or without a physically visible SISA. For example, the SISA could only be an area of space in front of the typist's fingers that is sensed through trigonometrically calculated locations based on inputs or sensors attached to the typist's fingers, wrists and/or other body parts potentially in combination with inputs or sensors that are attached to physical objects in the typist's vicinity.

The typist need only be able to perceive which letter is being approached with the typist's movement of stretching out a finger.

This can be accomplished by a projection of a physically visible SISA in front of the typist's fingers or a SISA that is not physically visible which in either case gives the typist feedback as to which key the typist is approaching with the most outstretched finger. For example the typist could be typing in mid air with no physical keyboard in front of the typist. The typist could see a visible keyboard elsewhere, for instance on a computer monitor which can be a portion of the monitor which is normally associated with a computer. Alternatively it can be the computer that visibly responds to the typist's input to the SISA in front of the typist fingers. The SISA could be in the form of a visual projection of a keyboard elsewhere at a distance that the typist can see. The visual embodiment of the keyboard could first show the entire keyboard and then show only a section of the keyboard that is in the area of the typist's most outstretched finger.

An individually typed key would only be chosen when one of the typist's fingers is essentially outstretched towards an individual key and after the smaller area of the keyboard is enlarged to cover the whole SISA. Through the software appurtenant to the physical devices and both together (among other aspects) being covered by this invention, the typist can adjust the sensitivity of how “fully” the finger must stretch towards the area of an individual representation of an individual key in mid air, or on the SISA, in order to effect the selection to type that individual key.

The invention that relates to an apparatus, system and method is further described with reference to the following drawings.

### BRIEF DESCRIPTION OF THE DRAWINGS

FIG. 1A is a view of a small keyboard system for a computer.

FIG. 1B is a view of the blown up portion of a keyboard to be activated by a typist in accordance with the invention.

FIG. 2 is a graphical illustration of a keyboard system for a second computer or hand held PSD, in the nature of a bar code reader with a small keyboard.

FIG. 3 is a block diagram of an exemplary computer system for practicing various aspects of the invention.

FIG. 4 is a schematic illustration of a keyboard device of the invention in relation to a keyboard processor.

### DETAILED DESCRIPTION OF THE PREFERRED EMBODIMENT

The present invention will now be described in detail with reference to a few preferred embodiments thereof, as illustrated in the accompanying drawings. In the following description, numerous specific details are set forth in order to provide a thorough understanding of the present invention.

An ergonomically reduced-sized keyboard for a qwerty keyboard layout or other keyboard layout permits for effective typing speed and accuracy relative to a conventional keyboard. The keyboard in one embodiment uses a touch screen concept, where in some situations, the fingers of the typist do not have to actually touch the screen. The screen can be sensitized that when the fingers of the typist approach the screen at select locations, an appropriate key is operated. Suitable electrical wiring configurations or wireless systems and connections can be used

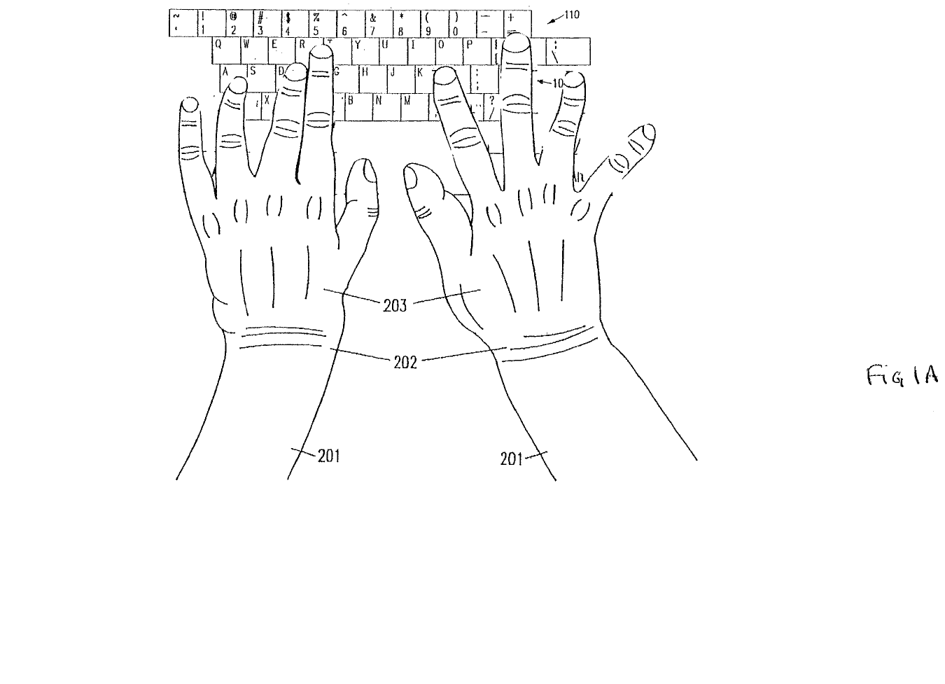

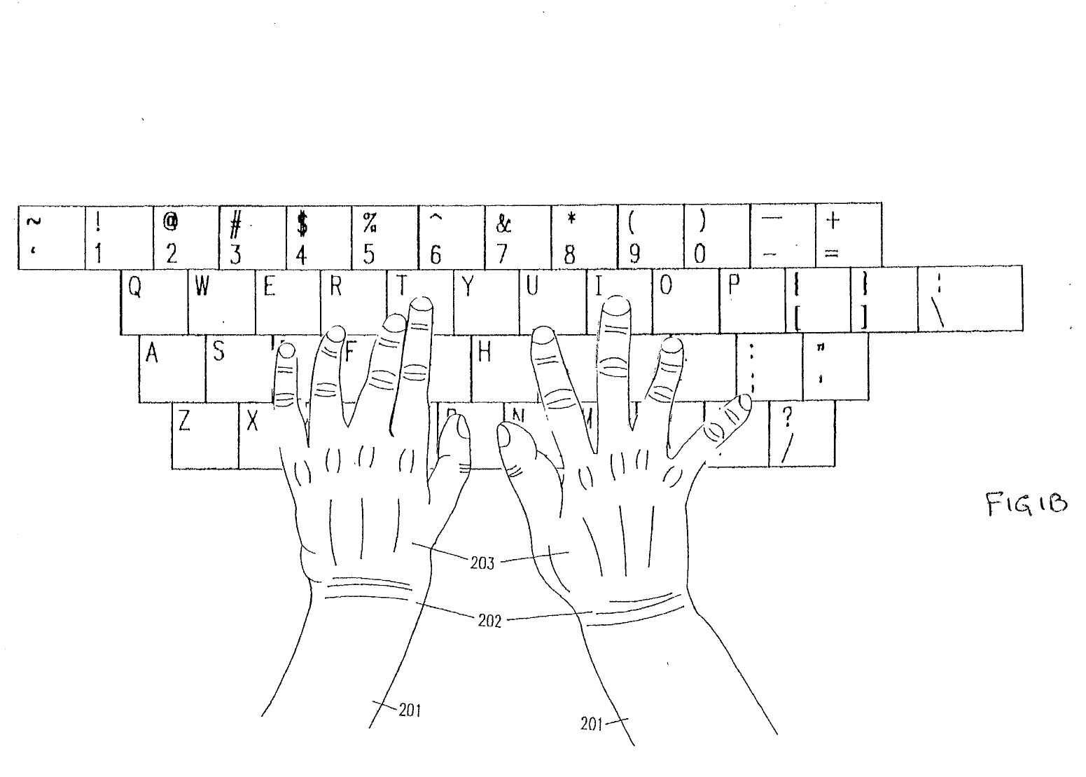

In FIG. 1A there is shown a conventional small qwerty keyboard 200 layout suitable for use with computers ranging from work stations to computers. The keyboard layout 210 is shown in a relatively full size keyboard format.

In the arrangement demonstrated, the arms 201 of the typist are shown relative to the wrists 202, hand 203 and the fingers 204. The keyboard according to the invention is illustrated in FIG. 1B and is of a nature that the screen which is depicted for use with the invention which shows any one of the letters or numerals or punctuation marks in a blown up form relative to that shows in FIG. 1.

Several of the letters can be shown in a blown up form on the screen relative to the keyboard. Only those letters in the vicinity of the fingers 204 which are about to touch the particular place of the keyboard can be blown up.

With the invention, the arrangement is of the nature that the fingers 204 and 205 can remain removed from the keys as necessary.

The configuration showing FIG. 1B shows the situation of a blown up keyboard on a screen face where the fingers are indeed able to be correctly spaced relative to the size of the keys. This configuration would be the effective use of the keyboard screen of the present invention. The present invention may effectively show the entire keyboard in its conventional space. The increased size of the touch screen ordinarily be parts of the keyboards. The actual physical elements of the keyboard on the physical device are relatively smaller than a physical relationship relative to the expanded visual relationship

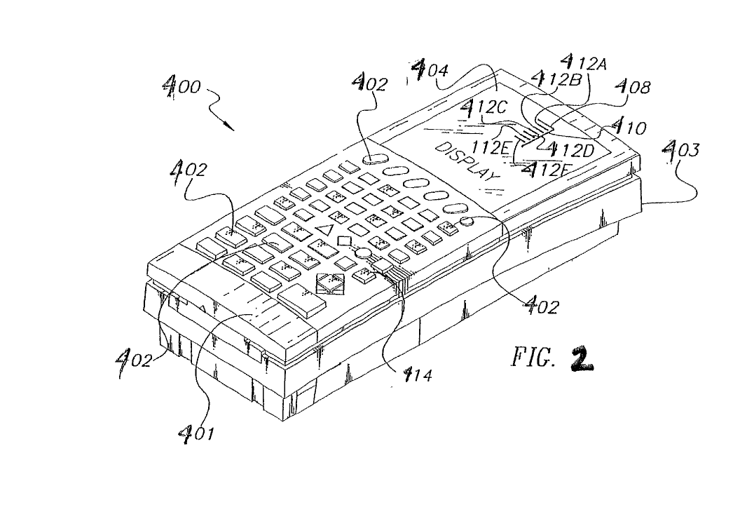

In FIG. 2 there is shown a portable bar code reader configuration which is a different form of computer which can be used with the present invention.

The portable bar code reader includes a keyboard having a plurality of keys for enabling a user to provide input to the portable bar code reader. Each of the plurality of keys transmits information having a preselected meaning to the bar code reader when depressed by the user. As is known in the art, the user can depress a plurality of key combinations to provide various information the bar code reader.

The keyboard 401 is mounted in a keyboard housing along with a display 404. The display is constructed for providing information from the bar code reader to the user of the bar code reader. The display may be any conventional electronic apparatus for displaying information to a user. As examples, the display may comprise a plurality of a light-emitting diodes (“LEDs”), a liquid crystal display, etc. Many other options for the display will readily become apparent to those skilled in the art.

The portable bar code reader 400 is constructed to enable a user to define a plurality of keyboard formats. As used herein, the term “keyboard format” refers to the meaning that is attributed to the plurality of keys 402. As an example, in a first format, a key may represent a “1” and, therefore, transmit a programatic representation of “1” to the bar code reader when activated. In a second format, the same key may represent “4” and transmit a programmatic representation of “4” to the bar code reader when activated.

The bar code reader 400 includes a unique meaning indicator (sometimes referred to as an ICON). The meaning indicator 408 includes an elongated indicator 410 and a plurality of meaning indicators 412-A-412-F. The plurality of meaning indicators are positioned in orthogonal relationship with respect to the elongated indicator 410. The plurality of meaning indicators are constructed to be selectively actuatable so that only a single meaning indicator is actuated at any time. The particular meaning indicator that is actuated provides an indication to the user of the keyboard format that is being used, i.e., the meanings that are being attributed to the plurality of keys 402.

A meaning key 414 is provided on the keypad 401 for changing the keyboard format. The meaning key includes a legend that matches the meaning indicator. By depressing the meaning key, the user can change the keyboard format from a first format to a second format. As discussed above, this change is indicated by actuating one of the meaning indicators. A plurality of keyboard formats can be provided so that the meaning key can be repeatedly activated until the desired format is selected as indicated by the meaning indicator.

The portable bar code reader is constructed to be used with a screen keypad, which can be movable and/or removable from the device. This screen keypad may be substituted for the first keypad. Each of the first and second keypads are constructed to be removeably coupled to the keyboard housing to construct a keyboard. Each of the first and second keypads includes apparatus for providing a keypad identification signal to the portable bar code reader.

Those skilled in the art will readily appreciate that a plurality of electrical and/or mechanical means or providing an indication to the portable bar code reader as to which keypad is coupled to the keyboard housing may be provided. The first keypad and the second screen pad include a keypad terminal for transmitting signals from the keypad to the portable bar code reader. Among the signal transmitted is a signal indicating the identification of the keypad coupled to the bar code reader housing.

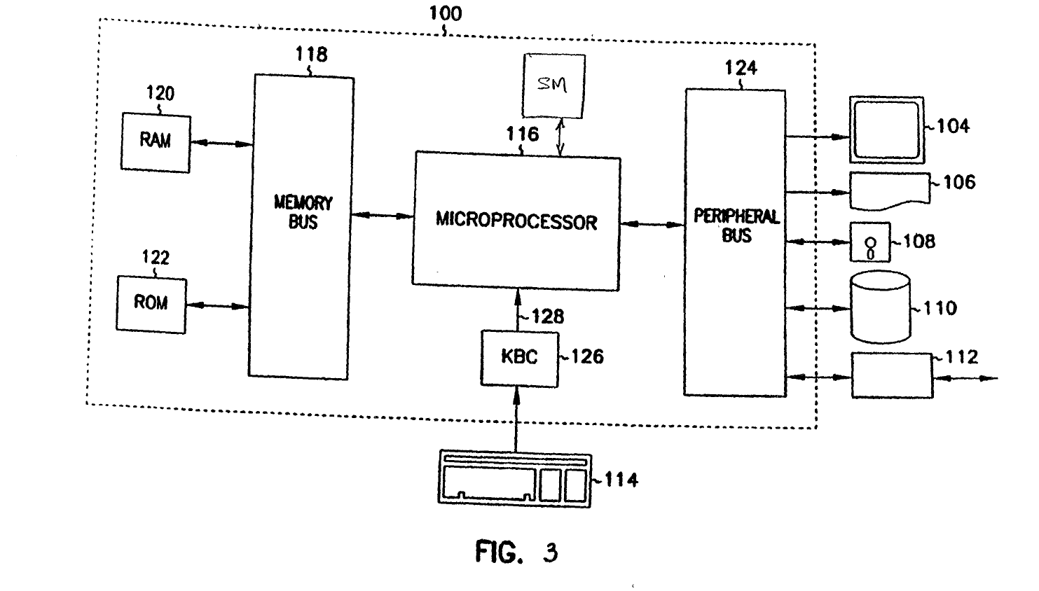

FIG. 3 is a block diagram of an exemplary computer system 100 for practicing various aspects of the invention. The computer system 100 includes a display screen or monitor 104, a printer 106, a disk drive 108, a hard disk drive 110, a network interface 112, and a keyboard 114. The computer system 100 includes a microprocessor 116, a memory bus 118, random access memory (RAM) 129, read only memory (ROM) 122, a peripheral bus 124, and a keyboard controller 126. The computer system 100 can be a personal computer, such as an Apple computer, e.g., an Apple Macintosh (TM), an IBM (TM) personal computer, or a compatible, a workstation computer, such as a Sun Microsystems (TM) or Hewlett-Packard (TM) workstation, or some other type of computer.

Microprocessor 116 is a general purpose digital processor which controls the operation of computer system 100. Microprocessor 116 can be a single-chip processor or can be implemented with multiple components. Using instructions retrieved from memory, the microprocessor 116 controls the reception and manipulation of input data and the output and display of data on output devices.

Memory bus 188 is used by the microprocessor 116 to access RAM 120 and ROM 122. RAM 120 is used by microprocessor 116 as a general storage area and as scratch-pad memory, and can also be used to store input data and processed data. ROM 122 can be used to store instructions or program code followed by microprocessor 116 as well as other data.

Peripheral bus 124 is used to access the input, output, and storage devices used by computer system 10. These devices include the display screen 104, printer device 106, disk drive 108, hard disk drive 110, and network interface 112. The keyboard controller 126 is used to receive input from the keyboard 114 and send decoded symbols for each pressed key to microprocessor 116 over bus 128.

The display screen or monitor 104 is an output device that displays images of data provided by microprocessor 116 via peripheral bus 124 or provided by other components in computer system 100. The printer device 106 when operating as a printer provides an image on a sheet of paper or a similar surface. Other output devices such as a plotter, typesetter, etc. can be used in place of, or in addition to the printer device 106.

The disk drive 108 and hard disk drive 110 can be used to store various types of data. The disk drive 108 facilitates transporting such data to other computer systems, and hard disk drive 110 permits fast access to large amounts of stored data.

Microprocessor 116, together with an operating system, operate to execute computer code and produce and use data. The computer code and data may reside on RAM 120, ROM 122, or hard disk drive 110. The computer code and data could also reside on a removable program medium and loaded or installed onto computer system 100 when needed. Removable program mediums include, for example, CD-ROM, PC-CARD, floppy disk and magnetic tape.

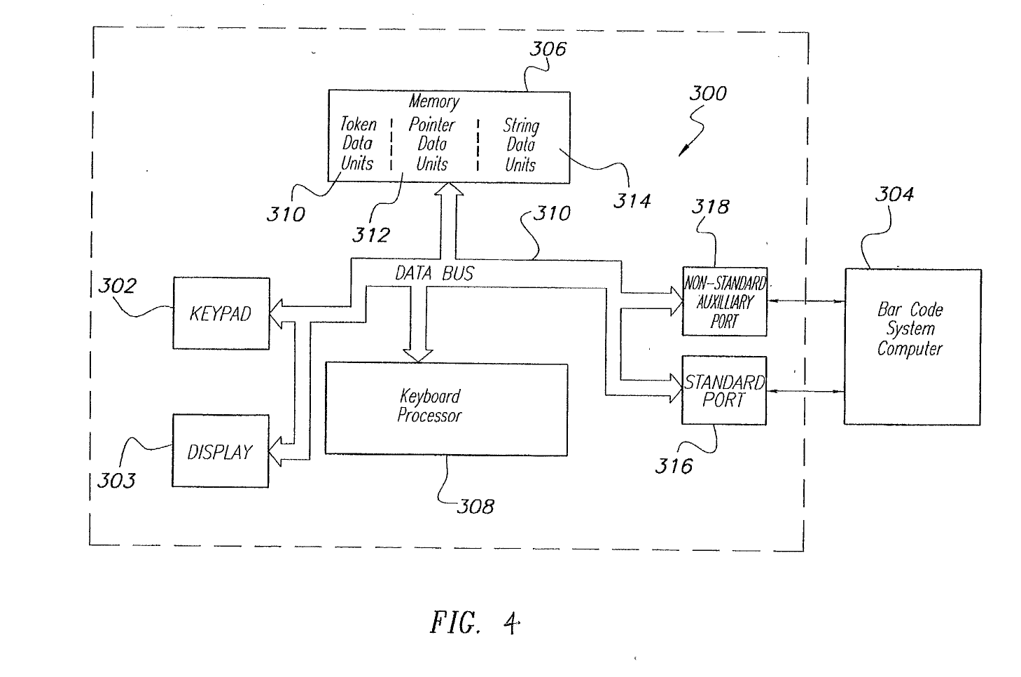

In FIG. 4 there is a more detailed description of the construction and operation of the keyboard 400 of FIG. 2. The portable bar code reader includes a keyboard 300 having a keypad 302 and display 303 coupled thereto. The display may comprise the same elements, or group of elements. The keypad may comprise separate physical devices, such as keypads, that are physically couplable to the bar code housing, as discussed above, and electrically couplable to the remainder of the keyboard. Alternatively, the keypads may be constructed as an integral part of the keyboard.

The keypad is constructed to provide a plurality of X-Y position signals in response to activation of the plurality of keys. Each of the plurality of X-Y position signals is associated with a respective one of the plurality of keys. The plurality of X-Y position signals are provided to a keyboard processor 308 via a data bus 310. In addition, the keypad provides a meaning signal to the keyboard processor over the data bus. The meaning signal may be provided by activating the meaning key. Additionally, the meaning signal may be provided as a result of activating the meaning key and provided the keypad identification signal, discussed above by reference to keyboard. Other apparatus and methods for providing the meaning signal will readily become apparent to those skilled in the art.

The keyboard is connected for transmitting electrical signals to and from a bar code system computer. As discussed briefly above, the bar code system computer comprises a conventional computer system constructed for operation in accordance with a conventional operation system. The computer system can operate in accordance with the MS-DOS operating system by Microsoft Corporation. However, those skilled in the art will appreciate that the bar code system computer could be constructed for operation in accordance with any conventional operating system without departing from the present invention.

An advantage to constructing the bar code system computer to operate in accordance with a conventional operating system is that the bar code system computer is capable of executing instructions from conventional computer programs written for conventional the conventional computer operating system. Examples of conventional computer programs that could be executed by the bar code system computer of the subject invention include Microsoft Access, Lotus 1-2-3, D-Base, etc. Those skilled in the art will appreciate that other conventional computer programs could be executed on the bar code system computer in addition to those discussed above. Furthermore, when constructed to operate in accordance with a different conventional operating system, different conventional computer programs can be executed by the bar code system computer.

The keyboard further includes the keyboard memory 306 constructed for communication with the keyboard processor over the data bus. The keyboard memory may be considered to include three memory portions, a token memory 310, a pointer memory 312, and string memory 314. Those skilled in the art will appreciate that although the token memory, point memory and string memory as integral part of the keyboard memory, that each of the token memory, pointer memory or string memory may comprise separate electrical elements.

General

An advantage of this invention is that a person can now type or activate a keyboard without needing to use any physical keyboard. Instead a person can type in a more mobile fashion. The typist can walk around the room while typing and never need be near a typical physical typing keyboard.

With this invention, the movements of the typist's fingers are remotely sent to the computer processor, optionally via the Internet, and the typist can functionally type by moving her or his fingers in mid air. The typist can functionally type in mid air while the typist looks at a monitor that may also be located farther away from the typist's body than is reachable by the typist. The monitor serves as a feedback device for the typist in that the monitor shows the layout of the keyboard and also shows the outline of the typist's fingers hovering over the letters of the keyboard even though the typist is for example, five feet, away from the monitor.

In actuality the typist hands and fingers are far enough away from the monitor that the typist cannot reach the monitor, but the triangulation devices that the typist is wearing are able to determine the relative points in mid air where the typist fingers are located as related to and compared to the outline of the typist's fingers as represented on the monitor.

This invention includes the appurtenant software program that in conjunction with the physical machinery of the triangulation devices worn by the typist, or used by the typist, enables the computer processor to correlate and calculate the position the typist is holding her or his fingers indicating the typing of letter(s). The typist can stand at a distance away from the monitor and computer. This distance is only limited by the distance that the remote or wireless devices can send the information to the computer and/or the needs of the typist to visually observe the computer monitor in order for the typist to receive feedback as to the precise finger movements needed to transmit the information to the computer processor so that the typist can succeed in typing accurately.

The typist can indicate that the typist is ready to type, for instance, by hitting a remote button that the typist wears on the typist's body and that causes the exact baseline locations in mid air of all of the typist's fingers to be input into the memory of the computer. Alternately the typist can set the program to only sense the locations of a limited number of the typist fingers. In this way the typist can “hunt and peck” with, for example two index fingers only in mid air without any physical typing keyboard. In any such configuration, the triangulation devices can sense when the typist moves a finger forward or downward from where that individual finger was previously and thus indicating that the typist intends to press a letter or key on the keyboard that is represented on the monitor which can be quite a distance away from the typist. When the triangulation devices sense that a finger is moved downwards, the outline of that specific finger on the monitor is caused to move downwards towards the letter or key on the typewriting keyboard that is also represented on the monitor. When the typist's finger is moved far enough downwards the letter desired is typed.

The sensitivity can be set with the appurtenant software program by the typist for the desired sensitivity or finger moving distance required for indication of the typist's desire to have successfully typed an individual letter by pressing the correlating key on the keyboard. So without a physical keyboard, a typist can be able to type while standing or walking around at a distance from a monitor. On the monitor there is a visual representation of the typewriter keyboard keys and letters. Also visible on the monitor is a representation of the outline of the typist's fingers hovering over the visible representation of the typewriter keys and letters.

The triangulation devices that the typist wears on the typist's body indicate which fingers move downwards and thus transmit to the computer via a wireless device the indication of the typist that the typist has typed a certain letter or letters. The computer sends a message to the monitor to show a respective movement in the drawing of the outline representing that individual finger of the typist. Thus the typist moves a finger and the outline that represents the typist's finger on the monitor also moves downward almost at the same time. Then, when the finger has moved far enough downwards, the appurtenant software program indicates that the specific key and letter has been typed. This can be indicated by a change in color of the key that the outline or representation of the finger had moved towards. At the same time, the computer inputs into memory that the specific key was typed and another area of the monitor that shows the typed text would now show the new letter typed. The key changes back to its original color when the typist lifts the same finger back to its original baseline position. This invention creates a more mobile computer and in one embodiment uses wireless connections to a processor.

The individual typist can access the software necessary to effectuate the typing system through the Internet. This invention also concerns the different embodiments and flexibility available to the typist through using the Internet to cause this invention to function in any location and with any individual customizations the individual typist may desire.

For example, the typist could log onto the internet with a wireless, small portable computer and his hand attachments which allow sufficient triangulation between them and may look like wrist bracelets and finger rings for the typing fingers that the typist uses to type. Through the triangulation or calculated location of the position of the fingers of the typist through sensing of the physical location of the typist's fingers, the typist is able to effectively type in mid air.

As one alternative, the typist could have memorized the typing keyboard and therefore may not need any physical representation of the keyboard. Another alternative is that the typist can choose to direct the software program either through the internet or directly through the nearby computer hardware to transmit a representation of the computer screen which can have a representation of the keyboard for feedback as to the location of each letter, number or symbol that is typed.

The representation could be transmitted back to the typist's portable wireless computer and the typist could then choose to send this image to any nearby television or computer screen or other monitor of any type through a wired or wireless connection. Alternatively the typist could direct the input or representation of the typed material to be sent directly from the machine of the Internet and specifically to a host to an address where there is a television, computer screen, or other monitor, or screen of any kind. The typist could also physically attach a wireless receiver to the input of any screen so that the signal sent, from the internet or specifically the web host or application service provider that remotely runs the software that carries out the functions of this invention, can be received by the specific screen that the typist desires.

The triangulation devices could alternately utilize radar, sonar, infrared, optical light pulses using different parts of the light spectrum, radio waves, and other methodologies to geographically record change in the position of the typist's fingers relative to their baseline position and then cause the computer to record or input the typing of an individual letter, letters, numbers, punctuation, symbols, instructions to the computer, and the like.

The triangulation devices that are used to determine the position of the typist's fingers could be placed on the shoulders of the typist, for example. The typist could additionally have sensors on his fingers so that the devices on the typist's shoulders could sense the changes in position of the typist's fingers. The typist could be watching the computer monitor which shows the representation of his fingers hovering over the typewriter keys also represented on the monitor. The typist easily sees the representation of her or his finger moving downwards towards the representation of the key under that drawing or representation of her or his finger. Then when the typist moves her or his finger downward enough for the setting of sensitivity, the key on the keyboard represented on the monitor appears to be “touched” by the representation of the “finger” and the computer inputs the information of that key having been typed.

An alternate embodiment is for the typist to type without selecting keys to type with his/her fingers but instead with his/her eyes in the following manner.

An image of the typist's eyes would be photographed by two or more cameras and the software program would calculate the direction of the typist's focus by triangulating from the cues of the rotation of the typist's eyeballs. The angle of each individual eyeball would be photographed at the moment that the typist so indicates through activating a switch with the movement of some other body part such as a finger. The two images of both of the typist's eyes simultaneously at the same instant can be analyzed mathematically using trigonometry and triangulation and knowing the distance of the keyboard from the typist's eyes to interpolate the location of the typist's focus at that instant and thus determine the specific key the typist intends to type.

The cameras can be placed in optionally different locations. The cameras could be on the keyboard itself, on special eyeglasses that the typist wears or elsewhere in the room in which the typist wishes to type.

The camera eyeball input can be facilitated by the use of the invention wherein the keyboard is narrowed down to a smaller group of letters in the are of the typist's initial gaze and then the keyboard is enlarged so the specific key that the typist is looking at and desires to type is more easily recognized or identified and typed by the machine.

It is clear that there are many permutations and combinations embodied by this invention and this description. The invention includes the system, apparatus and method of implementation. It will be apparent to one skilled in the art, that the present invention may be practiced without some or all of the specific details described.

The invention is to be determined according to the following claims.

What is claimed is:

1. A keyboard system for permitting typing or inputting of data to a receiving device comprising:
an input source responsive to the non-physical touch of fingers of an operator to generate an output signal;
a receiving device for the output signal; and
a software program with the input source and receiving device for coordinating and interpreting the output signal into discrete letters and other symbols commonly found on a typewriter or computer keyboard.

2. A keyboard system as claimed in claim 1 wherein the keyboard system takes much less space than a conventional keyboard for a PC computer.

3. A keyboard system as claimed in claim 1 including means for wirelessly connecting the input device to a computer processor.

4. A keyboard system as claimed in claim 1 including means for applying trigonometrical measurements of location in relation to fingers of a typist in relation to the input source.

5. A keyboard system as claimed in claim 1 including means for transmitting the movements of the fingers relative to an input source to a remotely located computer processor, optionally via the Internet.

6. A keyboard system as claimed in claim 1 including a monitor feedback device for a typist, the monitor being for showing the layout of the keyboard and the outline of the fingers hovering over the keyboard.

7. A keyboard system as claimed in claim 5 including a triangulation device for determining the relative points in mid air where fingers are located as related to and compared to the outline of the fingers as represented on the monitor.

8. A keyboard system as claimed in claim 6 wherein the triangulation device senses finger movement displayed on the monitor, which selectively represents the keyboard.

9. A keyboard system as claimed in claim 1 including means with a computer for transmitting a representation of a computer screen and for having a representation of the keyboard for feedback as to the location of keyboard letters, numbers or symbols, and means for transmitting the representation back to a typist's portable wireless computer.

10. A method of operating a keyboard system to permitting typing or inputting of data to a receiving device comprising:
inputting data to an input source
causing the input source to respond to the non-physical touch of fingers of an operator to generate an output signal; and
causing a software program connected between the input source to coordinate and interpret the signal into discrete letters and other symbols commonly found on a typewriter or computer keyboard.

11. A method as claimed in claim 10 including wirelessly connecting the keyboard to a computer processor.

12. A method as claimed in claim 10 including using trigonometrical measurements of location in relation to fingers of a typist.

13. A method as claimed in claim 10 including transmitting the movements of the fingers remotely to a computer processor, optionally via the Internet.

14. A method as claimed in claim 10 including feeding back information to a typist for showing the layout of the keyboard and the outline of the fingers hovering over the keyboard.

15. A method as claimed in claim 14 including triangulating information for determining the relative points in mid air where fingers are located as related to and compared to the outline of the fingers as represented on a surface, selectively a monitor.

16. A method as claimed in claim 15 wherein the triangulation senses finger movement displayed on a surface, which selectively represents the keyboard.

17. A method as claimed in claim 10 including transmitting a representation of a computer screen for having a representation of the keyboard for feedback as to the location of the keyboard letters, numbers or symbols, and transmitting the representation back to a typist's portable wireless computer.
